(19) United States
(12) Patent Application Publication
(10) Pub. No.: US 2014/0214501 A1
(43) Pub. Date: Jul. 31, 2014

(54) OFFLINE TO ONLINE PROMOTION METHOD

(71) Applicant: David Schilling, Pinecrest, FL (US)

(72) Inventor: David Schilling, Pinecrest, FL (US)

(21) Appl. No.: 13/751,629

(22) Filed: Jan. 28, 2013

(51) Int. Cl. G06Q 30/02; G06Q 50/00

(52) U.S. Cl. CPC G06Q 30/0218; G06Q 50/01
USPC 705/14.2

(57) ABSTRACT

An online promotion method where a promoter manages a system where a business provides to a customer a valuable offer for the goods or services provided by the business in exchange for the customer providing favorable feedback on a social network system or other designated website. The promoter manages the system to provide usage measurements and to ensure that the customer receives the promised valuable offer and the business received the promised valuable feedback.

### BACKGROUND OF THE INVENTION

1. Field of the Invention

The present invention relates to advertising and marketing, and more particularly, to a mobile device integrated social network promotion method.

2. Description of the Related Art

Several designs for social network promotion have been designed in the past. None of them, however, includes a mobile phone (or other device) bases system where a business can provide a special offer to a customer in exchange for that customer providing positive feedback on a social network for that business that increases the “fan” base of that business. The system further includes a backend management of the coordination of accounting for the promotions provided by the business, the social network results and the connection between the business and the customer.

Other systems are known that promote businesses utilizing social media with or without a mobile phone and others that distribute promotions via mobile devices. No other device or system is known to include the claimed features of the present method that uniquely produce a superior marketing result and a conversion result.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a method for businesses to improve their marketing effectiveness through social media.

It is another object of this invention to provide a way to get customers involved with businesses they interact.

It is still another object of the present invention to provide an economical and effective way for business to improve their image in the social networking arena.

It is another object of the present invention to increase geographic relevance with social network and other online marketing systems and methods.

It is yet another object of this invention to provide such a method that is inexpensive to manufacture and maintain while retaining its effectiveness.

It is another object of the invention to provide the ability of the business owner to automate the process and to reduce the need of third party marketer to assist in such a process. It is another object of the invention to provide analytics to prove the success rate of the process.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a schematic of a n example of the process as viewed from a Customer perspective.

FIG. 2 shows a flow chart of an example of the process as viewed from a Business perspective.

FIG. 3 illustrates an example of a Customer scanning a code to begin the process.

FIG. 4 is a representation of a code that a Customer might present to a Business to redeem an Offer.

FIG. 5 is a screen shot on a mobile device showing a social network page of a Business.

FIG. 6 is a screen shot of a redeemable code on a customer's mobile device.

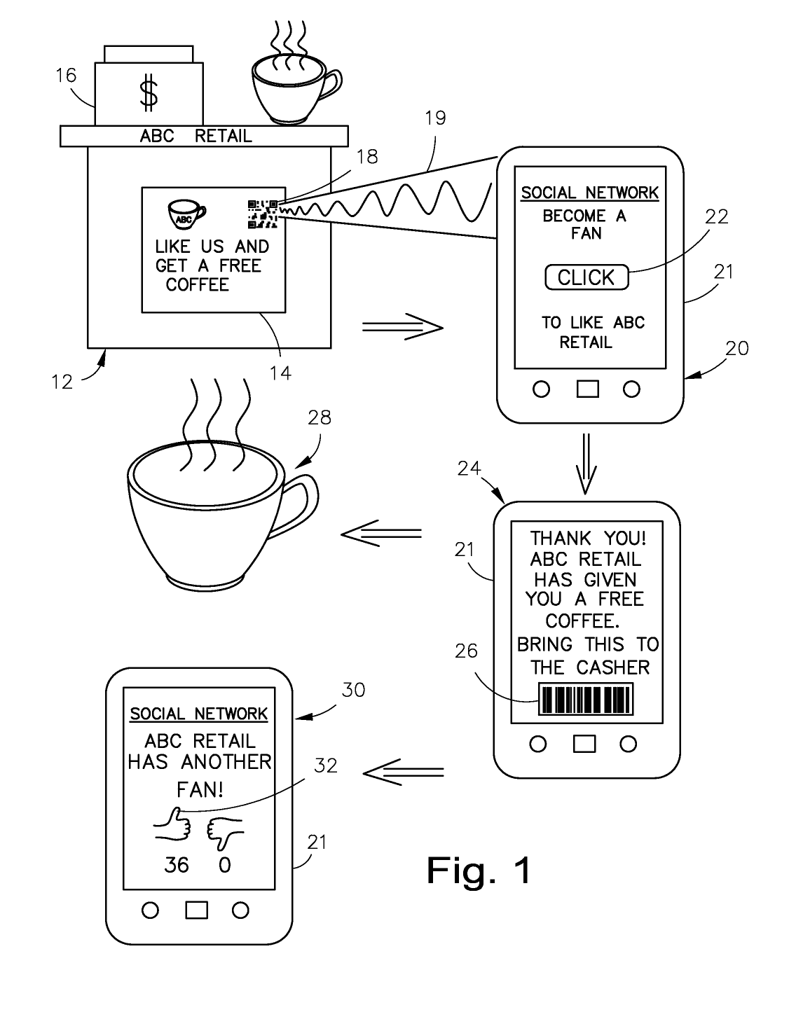

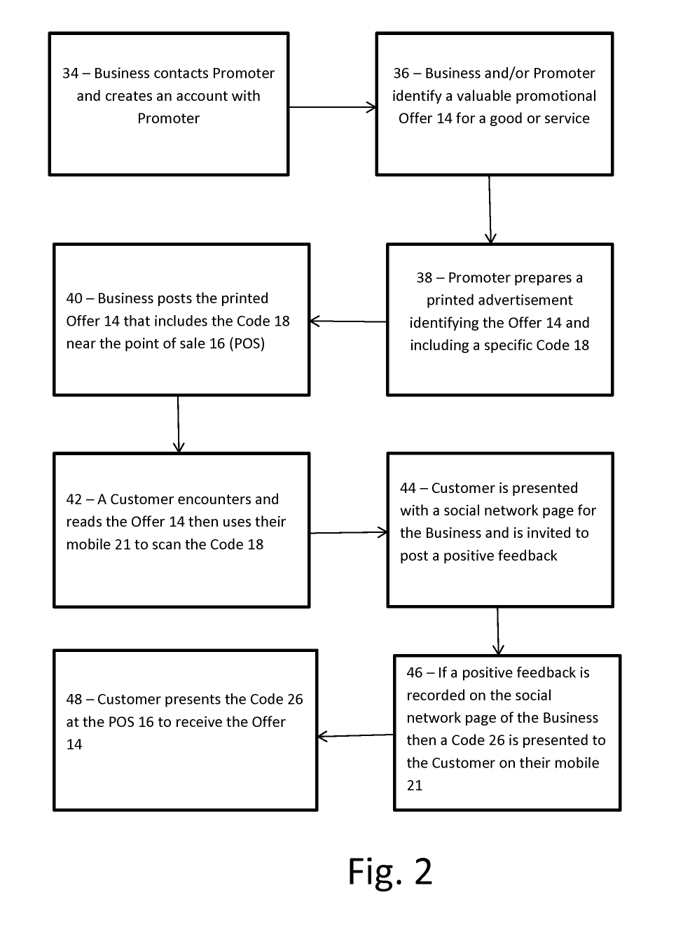

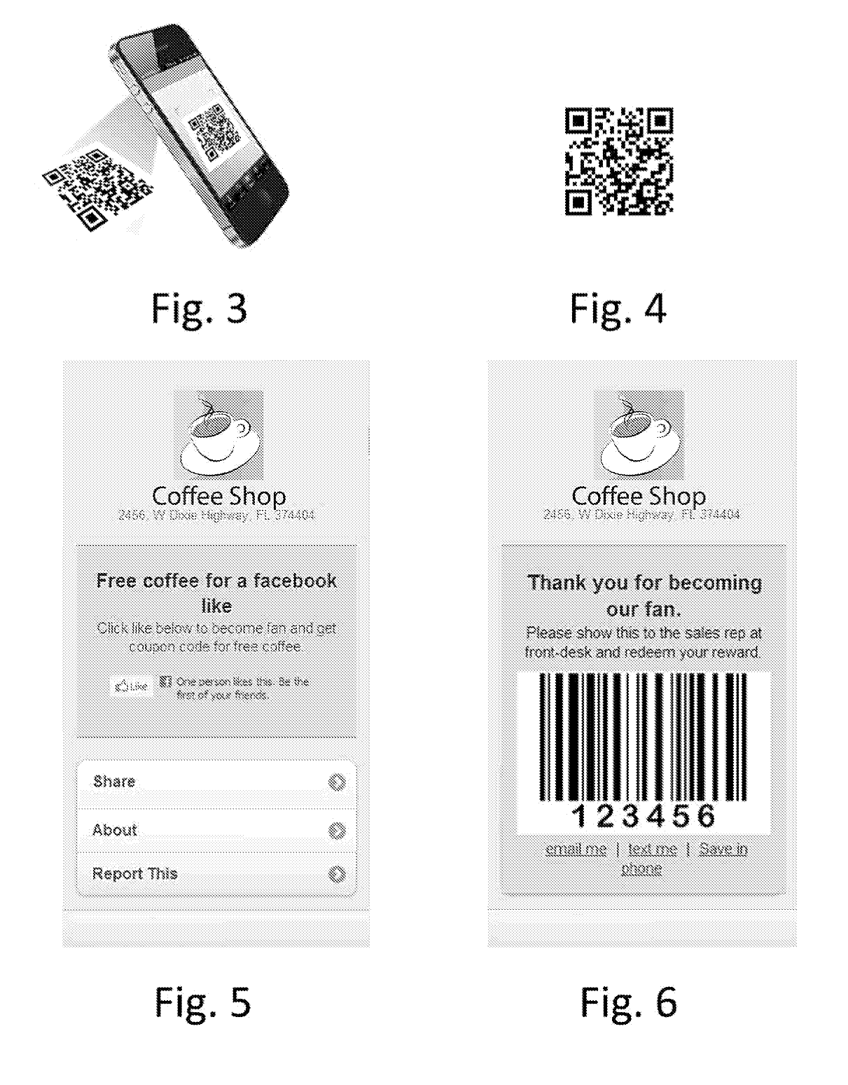

### DETAILED DESCRIPTION OF THE PREFERRED EMBODIMENT

The marketplace for competing business is cutthroat. Every company is looking for an edge to outperform their competition. One important avenue is to attract more customers and to retain existing customers.

A retailer that desires to improve their business has a plurality of options. Newspaper ads, coupons and the like have been popular over at least the past several decades. Similarly, word of mouth advertising can be beneficial to a business to expand a customer base.

Now, with the advent and expansion of online social networks, new opportunities to market are possible. Social networks provide a virtual forum for a wide variety of consumers to interact and share information. An important tool for a consumer to help evaluate whether to interact with a business can include information on how others have experienced that business.

Social networking allows not only individuals but also businesses to have a unique profile and information page. Just as an individual might have a listing of friends on their personal page, so too a business may have fans. In some social networks the visitors to a business' page may be able to add a positive or negative “like” or “don't like” indicator as to their feelings and experience about that business.

When an individual is evaluating whether to engage or interact with an unfamiliar business they will often evaluate that business based on the reports from other individual users. A business that has more positive feedback is frequently viewed as a more reliable entity with which to do business.

In other words, the more times that a business has been “liked” by users then the more likely that an unfamiliar user will find that business to provide satisfactory goods and services. If a business has been “liked” many times then by extension it must be popular and by further extension a new customer is also likely like that business.

A business with many “likes” or many “fans” is presumably popular for a reason. A consumer is reasonable to assume that repeated positive feedback from many similarly situated consumers is a strong indication that their experience with that business will likely be the similar and therefore the consumer is more likely to initiate a business relationship with that business.

And to the contrary, a business with many consumers indicating a “dislike” is an indicator that a business should be avoided. A business that does not have many or any “fans” can also be an indicator to a new customer that a business should be avoided.

It has become apparent that a business can be advantaged by increasing the volume of “likes”, “I dig it”, “fans”, a thumbs up or similar other positive indicators that appear on a social networking site. Simply stated, the more a group of consumers exhibits a positive sentiment about a company the more others are likely to seek out and engage that business thereby increasing a company's customer base.

The present invention encompasses a method for increasing the amount of positive indicators on the social networking page of a specific business. Generally, a business will partner with a promoter to coordinate a promotional campaign designed to entice customers to engage with a business' online presence. In a sense, it is a way to bring a consumer from the real world (analog world) into the digital realm of the internet and social networking.

There are three main classes of participants in this method: a business, a customer and a promoter. The promoter is an entity that sets up and manages the interaction between the business and customer to provide that the transaction progresses smoothly for both the business and customer and also provides some measuring and accounting to prove how effective the system is performing.

In a preferred version of the method and system the promoter's web application generates a customized and print ready display unit with QR code, a specific offer and campaign information. This information can be provided, to the business pre-printed or it may be digitally delivered, to the business so that they can print it and post it near the point of sale (POS) in their business or at some other strategic location where a customer is likely to encounter and interact with the display by reading and then scanning the QR code.

After scanning the offer code the display unit will take the customer to the mobile landing page the promoter's site and displaying the campaign or offer information and inviting the customer to complete a conversion or transaction involving a social media interface. Generally, a conversion is considered complete when a customer scans the printed offer code and delivers positive feedback to the business. The conversion is effective regardless of whether the customer actually claims the reward promised from the offer posted by the business.

When the customer executes the conversion action, for example posting a positive indication on the business' social media page then the promoter will cause the release and delivery of the reward, offer or information-alerts to the customer.

In the background (without any interaction from the consumer) the promoter gathers information about the transaction for data visualization to be made available to the business. The number and location where the customer scanned the offer as well as other data metric selectable by the promoter and business are made available to the business so that they may better advertise and promote their business based on how the customers behave.

It will be noticed that in some parts of this description a specific type of code is referenced, such as a QR code, bar code, RFID tag, near field communication (NFC) chips, a link address or other reference to represent data. It should be appreciated that these are mere examples and not an exhaustive or limiting list of the possible types of codes that are currently in use or that may become available during in the future and that are compatible of aiding in directing a mobile device to a specific web page.

Throughout this description the terms mobile, mobile phone, cell phone, display unit, mobile device and other similar terms are used and are to be understood to be interchangeable. This class of products is more broadly to be understood as any portable device capable of phone and/or internet communication. They generally must have the capability to receive an offer code from a business and access a social network page for that business and then to be able to receive and display a means to complete a transaction included in the offer from the business.

The terms reward, discount, offer, promotion and other similar terms are interchangeably used to identify an offer made to a prospective customer by a business. For example, these may include a percent discount on a future purchase, a free or discounted sample, an expedited restaurant reservation, a gift or any other good or service of value to a prospective customer.

The term social network or business' web page or site are intended to refer to any online site, page or portion of a page that is unique to a particular business. In other words, it is any online visual where a consumer can recognize that business uniquely and can view some detail of how other consumers feel about that business.

For example, the positive reviews may appear on a social website page for that business. Similarly, the positive reviews could be on other web pages that identify a business. A restaurant's review may be on a restaurant guide. A dentist may have reviews in a yellow pages type directory. These are but a couple of examples that could be equally effective as a traditional type of social networking site.

Ideally, this offer is of such a value to the customer to induce that customer to enter into the transaction embodied in this invention, specifically to post a positive feedback response to a publicly visible metric on a business' social network page. Essentially, other website visitors would see that previous visitors had a positive experience with that business.

The interface between the business and the promoter primarily occurs through the website of the promoter. It allows, among other features, to let the business use the web application to customize any of the following attributes for the campaign:

1. Conversion methodology—how the conversion will be made (QR code, NEC chips, Short URL, etc . . . )

2. Conversion medium—which social graph they want to populate; for example: facebook, twitter, google+ or any other social media site.

3. Reward—what are they offering (coupon code, information, digital goods, etc . . . to successful conversion of customer.

With above configurations the promoter's web application can selectively generate:

1. A QR code, a short URL (uniform resource locator) or other types of scannable code to print on the business' ad; or

2. Ready to print display units poster with the specific code and campaign detail embedded.

When people scan a display, for example, a QR code on a poster near a checkout counter, they will be sent to a landing page such as that shown in FIG. 5. Then, upon successful conversion, meaning that the “Like”, “Follow”, “plus” or other positive feedback is completed then the following actions are executed:

1. Display the reward/offer or information is sent to the customers mobile device such as the example in figure six; and

2. Simultaneously the visitor data for data visualization is captured by the promoter and can be imputed into a graphical chart or table for better analysis by the business and promoter; and

3. Optionally an alert can be sent to the customer via email/SMS or other available means

It should be noted that in a preferred version that the offer is not on the smartphone. Rather, the offer is in writing on a point of purchase display, or in advertising that references the business that is being promoted. The user takes a smartphone using a QR application (app) reader and reads a QR code that takes them to the “like” page showing the business. After selecting “like” it the user is then presented on his smartphone the response barcode with the redemption of the offer which the store can then scan on their POS or in other ways such as manual keying or merely showing it to a clerk to get a discount or other special offer on goods or services promoted by the business.

Referring to figure one, a graphical representation of the procedure as viewed from the perspective of the consumer is depicted. In step one 12 an offer 14 is posted near a POS 16. The offer 14 is comprised of a poster with an explanation of the offer 14 and code 18. In this example the code 18 is a QR code, but this could be any type of a phone readable code such as a bar code, RFID or other types of codes as described in the other examples described herein.

Step two 20 shows a mobile 21 that does a scan 19 of the code 18. The code 18 brings the mobile 21 device to a web page for the business where a button 22 is presented to provide a positive feedback for the business. As described above the positive feedback can take several forms but generally is a publicly visible indication that the customer likes the goods or services of the business.

Once the positive feedback is give step three 24 is reached where an indication on the mobile 21 shows that the positive feedback has been received and a code 26 is presented to facilitate the customer in obtaining the deal that was offered on the offer 14. In this example a cup of coffee 28 is given to the customer.

Simultaneously, the feedback 32 is recorded and displayed on a publicly visible web page 33 any device so that other potential customers can view the positive feedback generated by other users and then can make an informed decision on whether they also want to conduct affairs with that business.

Now referring to figure two where the process and methods are shown from the perspective of the business where in step 34 the business contracts with the promoter and creates an account on the promoter's website. The business may provide answers to specific questions to tailor the campaign. The promoter may also provide a specialist that can help the business better design an effective and cost-conscious campaign to market the business.

In step 36 the business and promoted work together to identify a promotional offer 14 that is attractive to a consumer. Generally this is a discount on goods or services provided by the business. However, other valuable things may equally be provided and are only limited by the creativity of the business and promoter.

In step 38 the promoter generated a printed or printable format sign or display that includes the offer 14 and a specific code 18 that related to the offer 14. As in step 40 this printed sign or display containing the offer 14 is place near the POS 16. Obviously the location of the sign may vary but is most often placed in or near the store where the offer 14 can be readily redeemed.

In step 42 the customer encounters the sign, reads the offer 14 and, if interested, scans the code 18 with their mobile 21. They are then provided in step 44 with a website relating to the business where they can then provide positive feedback about the business. In step 46 a positive feedback is recorded on eth business website and in exchange for receiving that feedback the business provides the customer with a code 26 on their mobile 21 device.

The customer then presents this code 26 to the customer service representative at the POS 16 of the business and receives the offer initially presented in step 38. Ideally both the customer is happy with the deal and the business is happy with the positive feedback. Other prospective customers see the positive feedback from the customer as generated in step 46 are more likely to do business that business even if they lack any experience that business.

It is possible that a customer may encounter a similar or the same offer from the same business on a new occasion. It is then selectable by the business whether they want to repeat the same offer or offer a new deal. For example, a repeat customer may be able to use the system for a rewards or loyalty type system to receive more benefits from the business the more they visit the business.

Equally effective may be where the business provides this promotion as a one-time only offer in exchange for the positive feedback. In that case the same phone or the same person will not be able to twice receive the special offer.

An important version of the invention can be fairly described as an online business promotion method comprised of a business posting a printed offer, such as a sign or poster, for a special on the goods and/or services provided by that business. The printed offer is visible to a prospective customer, for example near the cash register or in the storefront window. The printed offer includes a mobile phone readable first code, for instance a bar code, QR code or any other way that a phone can capture information easily. When said prospective customer causes a mobile phone to read said first code (on the poster) then the mobile phone is directed to a website, preferably owned and operated by the Promoter and said prospective customer is invited to provide a positive feedback about said business. When and if the prospective customer provides said positive feedback then a second code (i.e. barcode or any of the other types of codes listed herein or that may become available in the art) related to said printed offer is delivered to said mobile phone. Then, when the customer presents said business the second code then the customer is delivered said offer.

Important variations on this concept include that the offer is any of: a free sample, a buy-one-get-one-free, a gift card, rewards program. points or a percentage discount of a future purchase. Of course the creativity of the offer could be beyond the scope of this list and is intended to be merely exemplary of offers that prospective customers may enjoy.

Another variation of the idea is that the website could be any one of or combination of a social media site, a business review site, a business directory or the website of that business, Essentially this is intended to mean any online location where customers can see other customers' feedback about that business.

Yet another important variation is that any of the references codes may be a QR code, a bar code, a MD code, a readable uniform resource locator (URL) or an NFC chip. This list is not intended to be exhaustive or exclusionary, but is instead intended to mean any type of short range communication means where the customer can be physically near the sign, say for example about within visual eyesight range, so that the phone can capture the information on the offer.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An online promotion method comprised of a business posting a printed offer for a special on the goods and/or services provided by that business;
said printed offer is visible to a prospective customer;
said printed offer includes a mobile phone readable first code;
when said prospective customer causes a mobile phone to read said first code then the mobile phone is directed to a website and said prospective customer is invited to provide a positive feedback about said business;
if the prospective customer provides said positive feedback then a second code related to said printed offer is delivered to said mobile phone;
when the customer presents said business the second code then the customer is delivered said offer.

2. An online promotion method as in claim 1 further characterized in that said printed offer is any of: a free sample, a buy-one-get-one-free, a gift card, rewards program points or a percentage discount of a future purchase.

3. An online promotion method as in claim 1 further characterized in that said website is any of a social media site, a business review site, a business directory or the website of that business.

4. An online promotion method as in claim 1 further characterized in that said first code is any of a QR code, a bar code, a RFID code, a readable uniform resource locator (URL) or an NFC chip.
